(19) United States
(12) Patent Application Publication
(10) Pub. No.: US 2023/0210059 A1
(43) Pub. Date: Jul. 6, 2023

(54) CUTTING DEVICE WITH BLADE MOVING IN PARALLEL, MOVING METHOD AND PLANT TRIMMER

(71) Applicant: Shenzhen Huayu Agricultural Science and Technology Co., LTD, Shenzhen (CN)

(72) Inventor: Ken Guo, Shenzhen (CN)

(73) Assignee: Shenzhen Huayu Agricultural Science and Technology Co., LTD, Shenzhen (CN)

(21) Appl. No.: 18/121,028

(22) Filed: Mar. 14, 2023

(51) Int. Cl. A01G 3/033; B26D 1/147

(52) U.S. Cl. CPC A01G 3/033; B26D 1/147

(57) ABSTRACT

The present disclosure relates to a cutting device with a blade moving in parallel, a moving method and a plant trimmer. By the structural device, the round blade can be adjusted to be kept in vertical rising and dropping, and is always kept in parallel to the cutting mesh. By an adjustment knob, an adjustment screw is driven to rotate by a flexible shaft, so that the movable blade holder moves up and down, which completes the adjustment of the round blade in a visible region of the equipment.

### TECHNICAL FIELD

The present disclosure relates to the field of plant trimmers, in particular to a cutting device with a blade moving in parallel, a moving method and a plant trimmer

### BACKGROUND

In equipment for trimming flower buds, branches and leaves, a blade often needs to be removed for cleaning, and then are mounted back into the equipment. During assembling, it is necessary to ensure that a round blade is parallel to a cutting mesh, and to adjust a space between the round blade and the cutting mesh in real time according to a length of a residual leaf that needs to be reserved for a flower bud. In the existing equipment for trimming flower buds, branches and leaves, a plurality of screws are often combined to perform adjustment, which easily causes inconsistency in adjustment heights of the plurality of screws and leads to a problem of tilting of the round blade. Furthermore, a user needs to put a hand into a cutting bucket to perform operations, and visualized operations cannot be achieved.

### SUMMARY

The technical problem to be solved by the present disclosure is as follows: It is hard to ensure a blade to be kept in parallel to a cutting mesh during movement or a round blade tilts. For the above defects in the prior art, a cutting device with a blade moving in parallel, a moving method and a plant trimmer are provided.

In order to solve the above-mentioned problems, the technical solutions adopted in the present disclosure are as follows.

A cutting device with a blade moving in parallel is provided, including a cutting blade for cutting; a lower end of the cutting blade is connected with a movable blade holder, and the cutting blade rotates with the movable blade holder; a bottom of the movable blade holder is connected with a cutting motor; a rotating shaft of the cutting motor is connected with the movable blade holder, and the cutting motor drives the movable blade holder to rotate; a lower end of the cutting motor is connected with a supporting frame; the cutting device further comprises movable plates; a bearing pedestal and a bearing are arranged in the movable plates; the movable plates, the bearing pedestal and the bearing all pass through the motor rotating shaft; the movable plates are arranged between the motor and the movable blade holder; the cutting device further comprises an adjustment device for driving the movable plates to horizontally move; and when the adjustment device drives the movable plates to horizontally move, the bearing pedestal and the bearing move in a vertical direction, so as to drive the movable blade holder and the cutting blade to move in parallel in the vertical direction.

Preferably, the movable plates are connected with the supporting frame through a sheet metal base; guide pins are arranged on the sheet metal base; guide pin holes for inserting the guide pins are formed in the bearing pedestal; side surfaces of the movable plates are further provided with inclined guide slots in pairs; the bearing pedestal is connected with the movable plates through step pins; and when the movable plates move horizontally, the bearing pedestal moves in the vertical direction under the action of the inclined guide slots.

Preferably, the sheet metal base comprises a transverse supporting surface; a through hole for inserting the motor rotating shaft is formed in the transverse supporting surface; a side surface of the transverse supporting surface is provided with a plurality of gaps; the movable plates are provided with open slots corresponding to the gaps; the movable plates are removed from the sheet metal base by means of cooperation between the open slots and the gaps; and the open slots of the movable plates horizontally move on a side edge of the transverse supporting surface.

Preferably, the adjustment device includes a flexible adjustment shaft; one end of the flexible shaft is connected with an adjustment knob, and the other end is connected with an adjustment portion; and when the adjustment knob rotates, the flexible shaft drives the adjustment portion to rotate, so that the adjustment portion pushes the movable plates to move front and back.

Preferably, the flexible shaft is connected with the adjustment knob through a knob shaft and transmits a rotating signal; the knob shaft is connected with the supporting frame through a fixing portion; the adjustment portion is connected with the flexible shaft through an adjustment screw seat; and the adjustment screw seat is detachably connected with the sheet metal base.

Preferably, a length of the adjustment portion that is in contact with the movable plate is greater than a length of a projection of each guide slot in a horizontal direction; and a length of each guide pin that is connected with the bearing pedestal is greater than a height of a projection of each guide slot in the vertical direction.

A parallel moving method of a cutting device with a blade moving in parallel is provided, based on the above cutting device with a blade moving in parallel, the method including the following steps:

the adjustment knob is rotated to transmit a rotating signal to the adjustment portion through the flexible shaft, and the adjustment portion rotates relative to the movable plates to push the movable plates to horizontally move; and

when the movable plates horizontally move, the bearing pedestal moves only in the vertical direction to drive the cutting blade to move in parallel in the vertical direction, and the parallel movement and adjustment end.

A plant trimmer with a cutting structure with a blade moving in parallel is provided, including a barrel body for placing a plant to be trimmed; an agitation device for agitating the plant to be trimmed is arranged in the barrel body; the agitation device agitates the plant to be trimmed during rotation and strips the plant to be trimmed to obtain a material and a waste; a cutting mesh for cutting the waste is further arranged in the barrel body; the above cutting device for chopping the waste is further arranged at a lower end of the cutting mesh; the cutting blade changes the space from the cutting mesh when moving vertically; a material collection port is arranged at a side portion of the barrel body; a material collection tank is further arranged outside the material collection port; and a baffle plate is further arranged at the material collection port.

Preferably, an air intake adjustment plate is arranged at an upper end of the barrel body; fan vanes are further arranged in the cutting device; and a negative pressure is generated in the barrel body under the action of the fan vanes and the air intake adjustment plate, so that the waste enters a waste collection mesh through the cutting mesh.

Preferably, the agitation device includes at least one agitation finger; a length of each agitation finger is not greater than a radius of the barrel body; the agitation fingers are grille-shaped; and the material is attached to an inner wall of the barrel body as the agitation fingers rotate to generate a centrifugal force in the barrel body, and is thrown into the material collection tank under the action of the centrifugal force.

The present disclosure has the beneficial effects below: By the structural design, the rotating signal of the adjustment knob is transmitted to the adjustment portion through the flexible shaft, so as to drive the adjustment portion to push the movable plates to horizontally move. The round blade can be adjusted to be kept in vertical rising and dropping, and is always kept in parallel to the cutting mesh. By an adjustment knob, an adjustment screw is driven to rotate by a flexible shaft, so that the movable blade holder moves up and down, which completes the adjustment of the round blade in a visible region of the equipment. The automatic blade adjustment structure is simple. After the cleaning of the round blade is completed at each time, only simple screw locking is required, which can easily adjust the space between the round blade and the cutting mesh, without worrying about the parallelism.

The plant to be trimmed is stripped using the rotation of the agitation fingers. Since a fan is arranged in the cutting device, the negative pressure is generated in the barrel body due to adjustment of an air intake adjustment port. Thus, it is convenient for the waste to pass through the cutting mesh for cutting and collection. The material is rotated to be attached on the inner wall of the barrel body under the rotation of the agitation fingers, and is thrown into the material collection tank for collection under the action of the centrifugal force. Thus, the waste and the material are stripped for separate collection.

### BRIEF DESCRIPTION OF THE DRAWINGS

In order to describe embodiments of the present disclosure or technical solutions in the prior art more clearly, the present disclosure is further described below in combination with the accompanying drawings and the embodiments. The drawings in the following description are only part of the embodiments of the present disclosure. Those of ordinary skill in the art also can obtain other drawings according to these drawings without creative work.

FIG. 1 is a schematic exploded diagram of a cutting device according to a preferred embodiment of the present disclosure;

FIG. 2 is a three-dimensional diagram of an adjustment device and movable plates according to a preferred embodiment of the present disclosure;

FIG. 3 is a three-dimensional structural diagram of a bearing pedestal according to a preferred embodiment of the present disclosure;

FIG. 4 is a three-dimensional structural diagram of a sheet metal base according to a preferred embodiment of the present disclosure;

FIG. 5 is a three-dimensional structural diagram of movable plates according to a preferred embodiment of the present disclosure;

FIG. 6 is a three-dimensional diagram of a plant trimmer according to a preferred embodiment of the present disclosure;

FIG. 7 is an exploded diagram of a plant trimmer according to a preferred embodiment of the present disclosure;

FIG. 8 is a three-dimensional structural diagram after a barrel body is removed according to a preferred embodiment of the present disclosure;

FIG. 9 is a three-dimensional diagram of a barrel body structure according to a preferred embodiment of the present disclosure; and

FIG. 10 is a three-dimensional structural diagram of a material collection tank according to a preferred embodiment of the present disclosure.

### DETAILED DESCRIPTION OF THE EMBODIMENTS

In order to make the objectives, technical solutions and advantages of the embodiments of the present disclosure clearer, the technical solutions in the embodiments of the present disclosure will be described clearly and completely below. Obviously, the embodiments described are part of the embodiments of the present disclosure, not all the embodiments. All other embodiments obtained by those of ordinary skill in the art based on the embodiments in the present disclosure without creative work shall fall within the protection scope of the present disclosure.

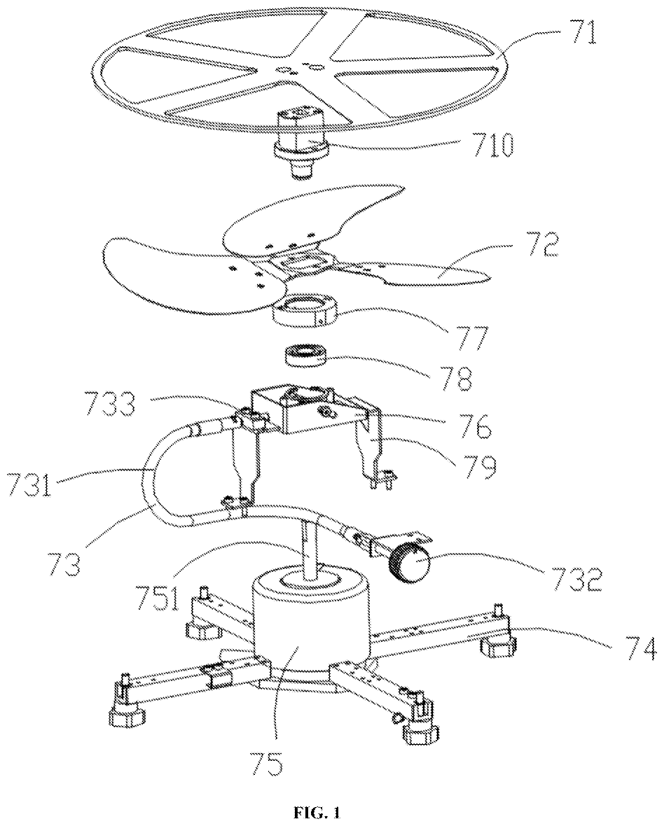

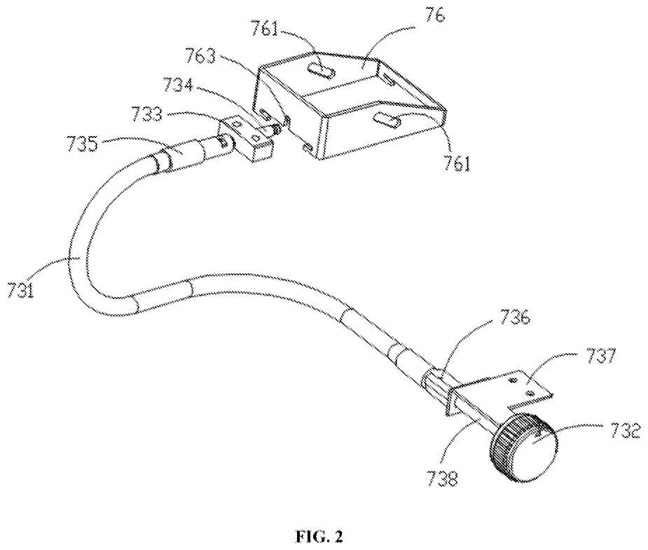

A cutting device with a blade moving in parallel according to a preferred embodiment of the present disclosure, as shown in FIG. 1 to FIG. 2, includes a round blade 71 for cutting a plant. A lower end of the round blade is detachably connected with a movable blade holder 710, and the round blade can rotate with the movable blade holder. A hole is formed in a lower end of the movable blade holder. A cutting motor 75 inserted into the hole is arranged below the movable blade holder. A motor rotating shaft 751 of the cutting motor is inserted into the hole. When the cutting motor works, the motor rotating shaft 751 is driven to rotate to drive the round blade 71 to rotate for cutting. A lower end of the motor supports and fixes the cutting device through a supporting frame 74. A sheet metal base 79 is further arranged above the cutting motor 75. A bottom of the sheet metal base is fixed on the supporting frame. The sheet metal base is fixed on the supporting frame through the motor rotating shaft 751. Movable plates 76 passing through the motor rotating shaft are further arranged above the sheet metal base. A bearing pedestal 77 is arranged in the movable plates. A bearing 78 is arranged in the bearing pedestal. Both the bearing pedestal and the bearing are disposed in a manner of passing through the motor rotating shaft. When the motor rotating shaft rotates, the movable plates, the bearing pedestal and an outer ring of the bearing do not rotate. The bearing is divided into an inner ring and the outer ring. The inner ring rotates with the motor rotating shaft, and the outer ring is fixed on the bearing pedestal and will not rotate. Fan vanes 72 capable of rotating with the movable blade holder are further arranged on the movable blade holder 710. The fan vanes are arranged below the round blade. The cutting device 7 further includes an adjustment device 73 for enabling the movable plates 76 to move front and back. One end of the adjustment device 73 is connected with the movable plates, and the other end is fixed on the supporting frame 74. When the movable plates 76 move front and back, the bearing 78 and the bearing pedestal 77 move up and down relative to the sheet metal base 79, so that the round blade moves in parallel in a vertical direction.

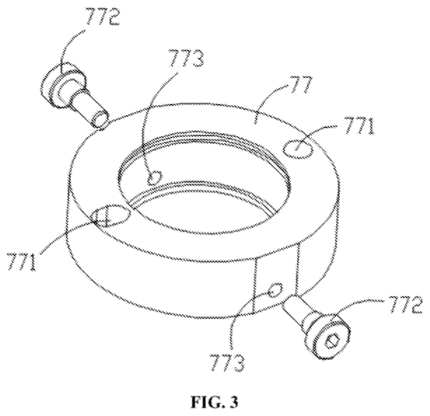

Further, as shown in FIG. 3 to FIG. 5, side surfaces of the movable plates 76 are provided with inclined guide slots 761 in pairs. The bearing pedestal 77 is arranged in the movable plates, and the movable plates are connected with the bearing pedestal through step pins 772. Step pin insertion holes 773 corresponding to the step pins 772 are formed in the bearing pedestal. The step pins pass through the guide slots and are inserted into the step pin insertion holes 773 to realizer relative movement between the movable plates and the bearing pedestal. The sheet metal base 79 is arranged at lower ends of the movable plates. Two guide pins 791 are arranged on the sheet metal base. The guide pins are arranged in the movable plates, and guide pin holes 771 opposite to the guide pins are formed in the bearing pedestal. The bearing pedestal can only move in the vertical direction through the guide pins. When the movable plates 76 move front and back, due to the inclined guide slots, the step pins slantways move in the guide slots. At this time, the step pins move in both a horizontal direction and the vertical direction. However, the step pins are connected with the bearing pedestal, and the bearing pedestal is fixed on the guide pins to move in the vertical direction, so that the movable plates move horizontally to drive the bearing pedestal to move in the vertical direction.

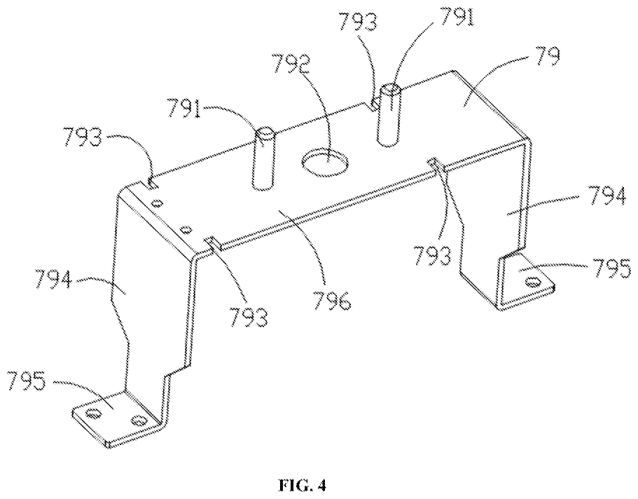

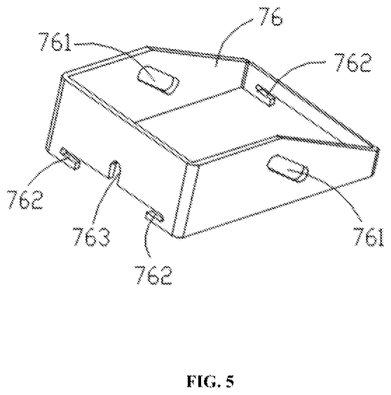

Further, as shown in FIG. 4 to FIG. 5, in order to make the movable plates 76 steadier during the horizontal movement on the sheet metal base 79, the sheet metal base is n-shaped, which is composed of a transverse supporting surface 796 and two vertical supporting surfaces 794. Fixed surfaces 795 are arranged at bottoms of the two vertical supporting surfaces. The fixed surfaces are fixed on the supporting frame 74 by using screws to improve stability of the sheet metal base. A motor rotating shaft hole 792 for allowing the motor rotating shaft 751 to pass is formed in the transverse supporting surface 796. The two guide pins are arranged on the transverse supporting surface in a manner of facing away from the vertical supporting surfaces. A plurality of gaps 793 are further formed in a side edge of the transverse supporting surface. There are four gaps in total. Open slots 762 corresponding to the gaps are formed in a bottom of the movable plate, so as to facilitate removal of the movable plate from the sheet metal base. There are four open slots in total distributed at the bottoms of the movable plates, and each pair of open slots has opposite openings. When the gaps are in correspondence to the open slots, the movable plate on one side can be removed first, and the movable plate on the other side is then removed, thus separating the movable plates from the sheet metal base. At regular times, the transverse supporting surface 794 moves in the open sots, so that the movable plates horizontally move.

Further, as shown in FIG. 2, the adjustment device 73 includes a flexible shaft 731. One end of the flexible shaft is connected to the movable plates, and the other end is connected with an adjustment knob 732. The adjustment knob 732 is connected with a flexible shaft input end 736 through a knob shaft 738. The other end of the flexible shaft is connected with the adjustment portion 734 through a flexible shaft output end 735. An adjustment screw seat is arranged at a periphery of the adjustment portion 734. An adjustment device guide slot 763 corresponding to the adjustment portion is arranged on one side of the movable plates. When the adjustment knob 732 is rotated, the knob shaft 738 drives the flexible shaft 731 to rotate, so as to drive the adjustment portion to rotate. An end portion of the adjustment portion is spiral, so that the adjustment portion can adjust, in the adjustment device guide slot, the horizontal movement of the movable plates. In order to make the adjustment device 73 transmit rotation more stably, one end of the knob shaft 738 is fixed on the supporting frame 74 through a knob shaft fixing portion, and the adjustment screw seat 733 is fixed on the sheet metal base 79 through a nut. In order to avoid the adjustment portion from being separated from the movable plates when the movable plates move, a length of the adjustment portion that is in contact with the movable plate shall be greater than a length of a horizontal projection of each guide slot; and a length of a vertical projection of each guide slot shall be less than a height of each guide pin, so that when the movable plates move in the guide slots, the bearing pedestal will not be separated from the guide pins. The problem of inclination of the cutting blade is also avoided by fixing the bearing pedestal by the two guide pins.

During working, when the cutting motor 75 drives the motor rotating shaft 751 to rotate after being powered on, the motor rotating shaft rotates to drive the movable blade holder 710 to rotate, so that the fan vanes and the round blade rotate together with the movable blade holder to perform cutting. When the position of the round blade in the vertical direction needs to be adjusted, the adjustment knob 732 is rotated. A rotating signal is transmitted to the adjustment portion 734 through the flexible shaft 731. The adjustment portion rotates in the adjustment device guide slot 763 to push the movable plates to horizontally move. Since the movable plates horizontally move, a certain point on the inclined guide slot 761 moves relatively in both the horizontal direction and the vertical direction. Under the action of the step pins 772, the bearing pedestal moves in the guide slots relatively in the horizontal direction and the vertical direction. The bearing pedestal is arranged on the guide pins 791 and cannot move in the horizontal direction. Therefore, the bearing pedestal 77 can only move in the vertical direction. Thus, the movable plates move horizontally, and the bearing pedestal only moves in the vertical direction. When the bearing pedestal moves in the vertical direction, the bearing pedestal drives the movable blade holder 710 to move only in the vertical direction, so that the round blade 71 moves in parallel in the vertical direction.

A moving method of a cutting device with a blade moving in parallel according to a preferred embodiment of the present disclosure includes the following steps:

Step 1: the adjustment knob is rotated to transmit a rotating signal to the adjustment portion through the flexible shaft.

Step 2: the adjustment portion pushes the movable plates to horizontally move.

Step 3: the movable plates horizontally move to adjust the movement of the bearing pedestal in the vertical direction.

Step 4: the movement of the bearing pedestal in the vertical direction drives the round blade to move in parallel in the vertical direction.

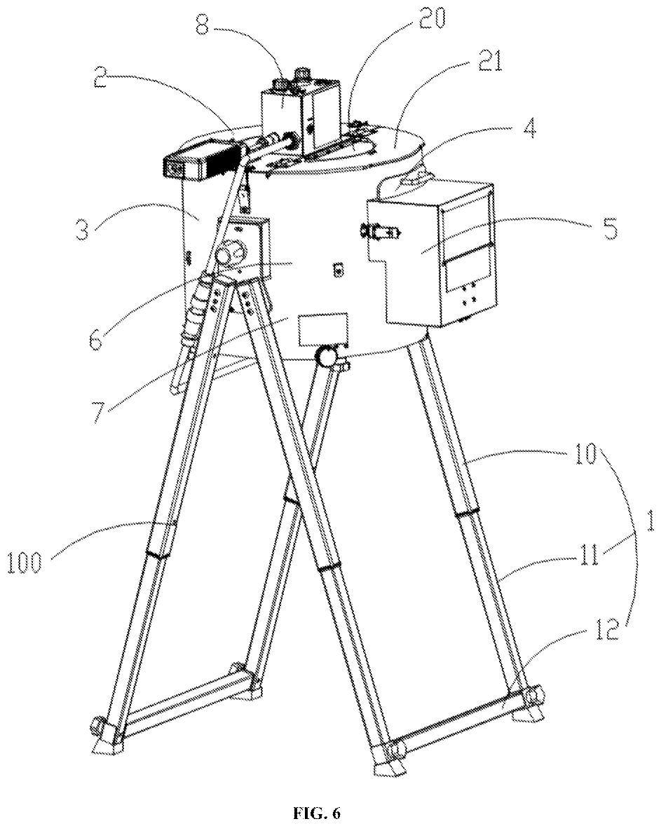

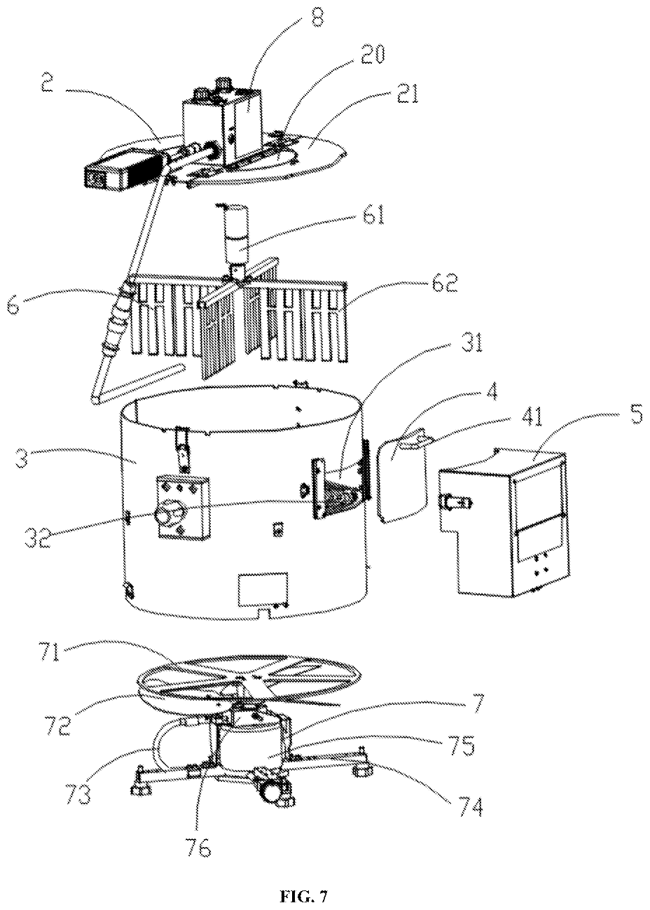

A plant trimmer with a cutting device with a blade moving in parallel according to a preferred embodiment of the present disclosure, as shown in FIG. 6 to FIG. 7, includes a material barrel body 3. The material barrel body is of a barrel-shaped structure having openings in a top and a bottom. An upper end of the barrel body 3 is provided with an upper cover plate 2. A plant to be trimmed is added to the barrel body by opening or closing the upper cover plate. An agitation device 6 for agitating the plant to be trimmed is further arranged in the barrel body. A cutting mesh 32 for separating a waste after trimming from a qualified material after trimming is further arranged in the barrel body. A cutting device 7 for chopping the waste after trimming is arranged at a position, close to the bottom of the cutting mesh, inside the barrel body. The cutting blade changes a space from the cutting mesh when it moves vertically, thereby adjusting the space between the cutting blade and the cutting mesh in real time. A material collection tank 5 for collecting the qualified material after trimming is further arranged at a side portion of the barrel body. A lower end of the barrel body is further connected with a waste collection mesh (not shown in the figure). The waste collection mesh can be removed from the barrel body, so that it is convenient to treat the waste in the waste collection mesh. In order to facilitate the placement and carrying of the plant trimmer, a telescopic support 1 for supporting the barrel body is further arranged at the lower end of the barrel body. A control box 8 for controlling a working state of the trimmer is further arranged at an upper end of the upper cover plate.

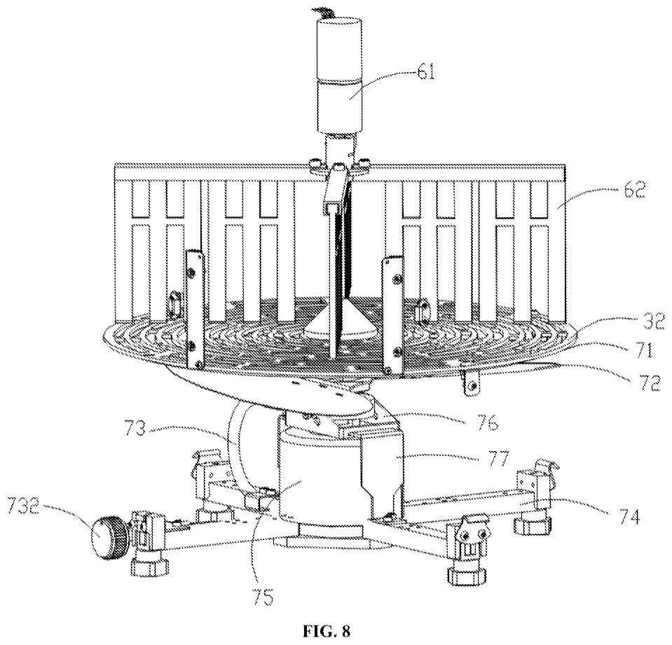

Further, as shown in FIG. 6 to FIG. 8, in order to facilitate the separation of the waste from the qualified material, the agitation device 6 includes a plurality of agitation fingers 62, and an agitation motor 61 for driving the agitation fingers to rotate. A radius of each agitation finger is basically the same as that of the barrel body 3, or is not greater than that of the barrel body 3. In order to facilitate stripping of the qualified material of the plant to be trimmed from the waste, the agitation fingers 62 are preferably grille-shaped. A radius of the waste after stripping is less than that of a mesh hole of the cutting mesh 32, so that the waste falls off from the mesh holes of the cutting mesh and is chopped. The waste is further chopped under the action of the cutting device 7. The cutting device is provided with the fan vanes 72, and an adsorption force generated by the rotation of the fan vanes also accelerates the process that the chopped waste enters the waste collection tank. Since the radius of the qualified material after stripping is greater than that of the mesh hole of the cutting mesh 32, the qualified material will be accumulated at the top of the cutting mesh, rotates with the rotation of the agitation fingers, and is attached to an inner wall of the barrel body 3 under the action of a centrifugal force. A material outlet 31 is arranged on a side wall of the barrel body. As the agitation fingers rotate, the qualified material attached to the inner wall of the barrel body is discharged from the material outlet under the action of the centrifugal force. The material collection tank 5 is further arranged at the material outlet. When a distance between the round blade and the cutting mesh needs to be adjusted, a reference will be made to the foregoing parallel movement of the cutting device, and repeated descriptions will not be made here.

Further, as shown in FIG. 7, in order to adjust air flowing in the barrel body, an air intake adjustment plate 20 is arranged above the upper cover plate 2. Air entering the barrel body is adjusted through the air intake adjustment plate. A negative pressure is generated in the barrel body under the action of the fan vanes, so as to facilitate the collection of the waste.

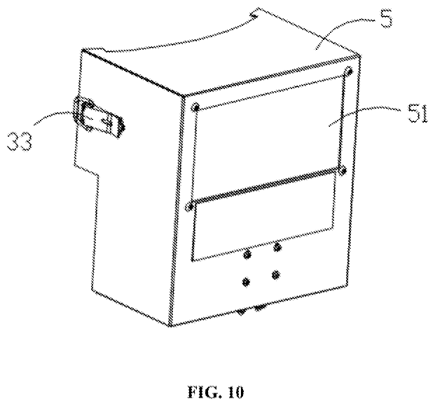

Further, as shown in FIG. 6 to FIG. 7 and FIG. 10, a baffle plate 4 for blocking the material outlet is arranged between the material outlet 31 and the material collection tank 5. When the trimmer just starts to work, the plant in the barrel body is not completely trimmed and stripped. At this time, the baffle plate 4 is inserted to block the material outlet. When the plant in the barrel body is completely trimmed and stripped, the baffle plate is pulled away through a handle 41 to open the material outlet, so that the qualified material after stripping is thrown into the material collection tank 5 under the action of the centrifugal force. The material collection tank is fixed in a manner of being inserted into an outer wall of the barrel body and is locked by a lock catch 33. It is also convenient for removal of the material collection tank and for the collection of the material after stripping. An observation window 51 is further arranged on the material collection tank 5. The observation window is a transparent device. A collection progress in the material collection tank can be directly observed through the observation window.

Further, as shown in FIG. 6 to FIG. 7, the telescopic support 1 includes upper supporting legs 10 and lower supporting legs 11. The upper supporting legs are telescopically inserted into the lower supporting legs to change a length of the telescopic support. The lower supporting legs 11 are fixed by support clamping rails 12. Meanwhile, an angle between two upper supporting legs 10 can also be adjusted. The upper supporting legs and the lower supporting legs adjust the length of the telescopic support by using a support height adjustment device 100. In the present disclosure, the support height adjustment device adopts a fastener type or a threaded type. Both cases shall fall within the protection scope of the present disclosure, and details will not be described here.

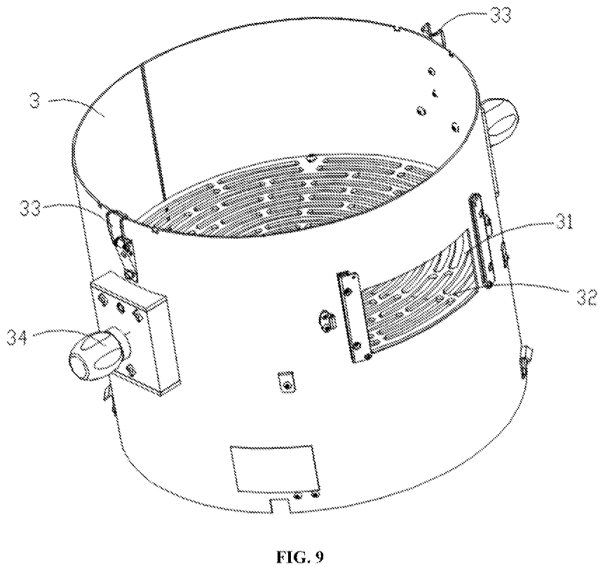

Further, as shown in FIG. 7 and FIG. 9, spherical handles 34 convenient for carrying the trimmer are further arranged on side surfaces of the barrel body 3. The spherical handles are arranged on two sides of the barrel body in pairs. The barrel body 3 and the upper cover plate 2 are locked by the lock catch 33, which is also convenient for removal of the upper cover plate from the barrel body. The plant trimmer of the present disclosure can be used for trimming chrysanthemums or mint leaves, but is not limited to the two kinds of plants. The plant trimmer can also strip and trim similar plants. These cases shall all fall within the protection scope of the present disclosure.

During use, a cover plate 21 for feeding is opened to add a material to be trimmed to the barrel body 3. The agitation motor 61 drives the agitation fingers 62 to rotate to trim and strip the material to be trimmed Under the action of the agitation fingers, the qualified material is stripped from the waste. The negative pressure is generated in the barrel body due to the gravity of the waste and the fan vanes 72, so that the waste is chopped by the round blade 71 after passing through the cutting mesh 32, and then enters the waste collection tank. Since the radius of the qualified material is larger than an aperture of the cutting mesh, lots of qualified materials are accumulated at the top of the cutting mesh. As the agitation fingers rotate, the qualified materials are attached to the inner wall of the barrel body under the action of the centrifugal force in the rotating process, and rotate with the agitation fingers. After the baffle plate 4 is pulled away, the qualified materials on the inner wall of the barrel body are discharged from the material outlet 31 in the rotating process, and enter the material collection tank 5. The collection progress of the material collection tank can be observed through the observation window 51. When the air flow and the negative pressure in the barrel body need to be adjusted, the air intake adjustment plate 20 is opened to let air enter the barrel body, thereby adjusting the negative pressure in the barrel body. When the distance between the round blade and the cutting mesh needs to be adjusted, a reference will be made to the description of the foregoing parallel movement of the cutting device, and repeated descriptions will not be made here.

It should be understood that the present disclosure is described by some embodiments. Those skilled in the art know that various changes or equivalent substitutions can be made to these features and embodiments without departing from the spirit and scope of the present disclosure. In addition, in the teachings of the present disclosure, these features and embodiments may be modified to adapt a particular situation and material without departing from the spirit and scope of the present disclosure. Therefore, the present disclosure is not limited by the specific embodiments disclosed herein, and all embodiments falling within the scope of the claims of the present application fall within the protection scope of the present disclosure.

What is claimed is:

1. A cutting device with a blade moving in parallel, comprising a cutting blade for cutting, wherein a lower end of the cutting blade is connected with a movable blade holder, and the cutting blade rotates with the movable blade holder; a bottom of the movable blade holder is connected with a cutting motor; a rotating shaft of the cutting motor is connected with the movable blade holder, and the cutting motor drives the movable blade holder to rotate; a lower end of the cutting motor is connected with a supporting frame; the cutting device further comprises movable plates; a bearing pedestal and a bearing are arranged in the movable plates; the movable plates, the bearing pedestal and the bearing all pass through the motor rotating shaft; the movable plates are arranged between the motor and the movable blade holder; the cutting device further comprises an adjustment device for driving the movable plates to horizontally move; and when the adjustment device drives the movable plates to horizontally move, the bearing pedestal and the bearing move in a vertical direction, so as to drive the movable blade holder and the cutting blade to move in parallel in the vertical direction.

2. The cutting device according to claim 1, wherein the movable plates are connected with the supporting frame through a sheet metal base; guide pins are arranged on the sheet metal base; guide pin holes for inserting the guide pins are formed in the bearing pedestal; side surfaces of the movable plates are further provided with inclined guide slots in pairs; the bearing pedestal is connected with the movable plates through step pins; and when the movable plates move horizontally, the bearing pedestal moves in the vertical direction under the action of the inclined guide slots.

3. The cutting device according to claim 2, wherein the sheet metal base comprises a transverse supporting surface; a through hole for inserting the motor rotating shaft is formed in the transverse supporting surface; a side surface of the transverse supporting surface is provided with a plurality of gaps; the movable plates are provided with open slots corresponding to the gaps; the movable plates are removed from the sheet metal base by means of cooperation between the open slots and the gaps; and the open slots of the movable plates horizontally move on a side edge of the transverse supporting surface.

4. The cutting device according to claim 1, wherein the adjustment device comprises a flexible adjustment shaft; one end of the flexible shaft is connected with an adjustment knob, and the other end is connected with an adjustment portion; and when the adjustment knob rotates, the flexible shaft drives the adjustment portion to rotate, so that the adjustment portion pushes the movable plates to move front and back.

5. The cutting device according to claim 4, wherein the flexible shaft is connected with the adjustment knob through a knob shaft and transmits a rotating signal; the knob shaft is connected with the supporting frame through a fixing portion; the adjustment portion is connected with the flexible shaft through an adjustment screw seat; and the adjustment screw seat is detachably connected with the sheet metal base.

6. The cutting device according to claim 4, wherein a length of the adjustment portion that is in contact with the movable plate is greater than a length of a projection of each guide slot in a horizontal direction; and a length of each guide pin that is connected with the bearing pedestal is greater than a height of a projection of each guide slot in the vertical direction.

7. A parallel moving method of a cutting device with a blade moving in parallel, based on the cutting device with a blade moving in parallel according to claim 1, the method comprising the following steps:
the adjustment knob is rotated to transmit a rotating signal to the adjustment portion through the flexible shaft, and the adjustment portion rotates relative to the movable plates to push the movable plates to horizontally move; and
when the movable plates horizontally move, the bearing pedestal moves only in the vertical direction to drive the cutting blade to move in parallel in the vertical direction, and the parallel movement and adjustment end.

8. A plant trimmer with a cutting structure with a blade moving in parallel, comprising a barrel body for placing a plant to be trimmed, wherein an agitation device for agitating the plant to be trimmed is arranged in the barrel body; the agitation device agitates the plant to be trimmed during rotation and strips the plant to be trimmed to obtain a material and a waste; a cutting mesh for cutting the waste is further arranged in the barrel body; the cutting device for chopping the waste according to claim 1 is further arranged at a lower end of the cutting mesh; the cutting blade changes the space from the cutting mesh when moving vertically; a material collection port is arranged at a side portion of the barrel body; a material collection tank is further arranged outside the material collection port; and a baffle plate is further arranged at the material collection port.

9. The plant trimmer according to claim 8, wherein an air intake adjustment plate is arranged at an upper end of the barrel body; fan vanes are further arranged in the cutting device; and a negative pressure is generated in the barrel body under the action of the fan vanes and the air intake adjustment plate, so that the waste enters a waste collection mesh through the cutting mesh.

10. The plant trimmer according to claim 8, wherein the agitation device comprises at least one agitation finger; a length of each agitation finger is not greater than a radius of the barrel body ; the agitation fingers are grille-shaped; and the material is attached to an inner wall of the barrel body as the agitation fingers rotate to generate a centrifugal force in the barrel body, and is thrown into the material collection tank under the action of the centrifugal force.
